(19) United States
(12) Patent Application Publication
(10) Pub. No.: US 2011/0141677 A1
(43) Pub. Date: Jun. 16, 2011

(54) MODULARIZED INDUSTRIAL COMPUTER TERMINAL

(76) Inventor: Chi-Tsun Cheng, Taipei Hsien (TW)

(21) Appl. No.: 12/636,793

(22) Filed: Dec. 14, 2009

(51) Int. Cl. G06F 1/16

(52) U.S. Cl. 361/679.08

(57) ABSTRACT

A modularized industrial computer terminal includes an upper cover and lower cover pivoted to each other. The upper cover has a display, and the lower cover has a keyboard and access unit. The display, key board, and access unit are electrically connected to an industrial computer main frame through a wire collecting module. The access unit has connecting module having USB or mini USB connectors and storage module having disc drive or hard drive.

### FIELD OF THE PRESENT INVENTION

The present invention relates to industrial computer, and particular to a modularized industrial computer terminal with good data accessing and operation.

### DESCRIPTION OF THE PRIOR ART

Computer is known as a data processing machine by electrical components and commands thereof. The components of a computer include a display, access unit such as hard drive, power supply, mother board, and interfaces. More components such as a processor, memory module, and interface cards are adapted to the mother board. Operating system, application programs, and data are stored in the access module serve to process calculating, networking with other components. Computers are widely used for solutions of daily life nowadays.

For the need of high performance in the industrials, industrial computers and main frame are arranged by layers in a rack. Such array system is high performance and space-saving.

Prior array system has a system rack. Industrial computer terminal or main frame is received by the rack through sliding guides as shown in FIG. 6. Normally, a standard height (height U) for common array system is 1.75 inch.

Industrial computer terminal usually has basic component like keyboard as an interface to input data and display for displaying information. For the popularization of portable storage device, industrial computers will also need access unit such as USB ports for mass data accessing.

In accordance with a Germany patent of No. DE20200601131U1, two receiving chambers are formed to two lateral sides of an industrial computer terminal for connection to sliding guides. In a front of the receiving chamber, USB port is arranged and the wiring for the USB port is in the receiving chamber.

However, such component is not modularized. It is also hard to remove and replace a component or wiring for all the components is independently connected to the main frame.

Therefore, a modularized industrial computer terminal is required for solving above disadvantage.

### BRIEF DESCRIPTION OF THE DRAWINGS OF THE INVENTION

FIG. 1 is a perspective view about the industrial computer terminal of the present invention.

FIG. 2 is an exploded view of the industrial computer terminal of the present invention.

FIG. 3 is an elevational view of the industrial computer terminal of the present invention, where the screen is opened.

FIG. 4 is a backside view of the industrial computer terminal of the present invention.

FIG. 5 shows that the industrial computer terminal of the present invention is in a close state.

FIG. 6 shows a prior art industrial computer terminal.

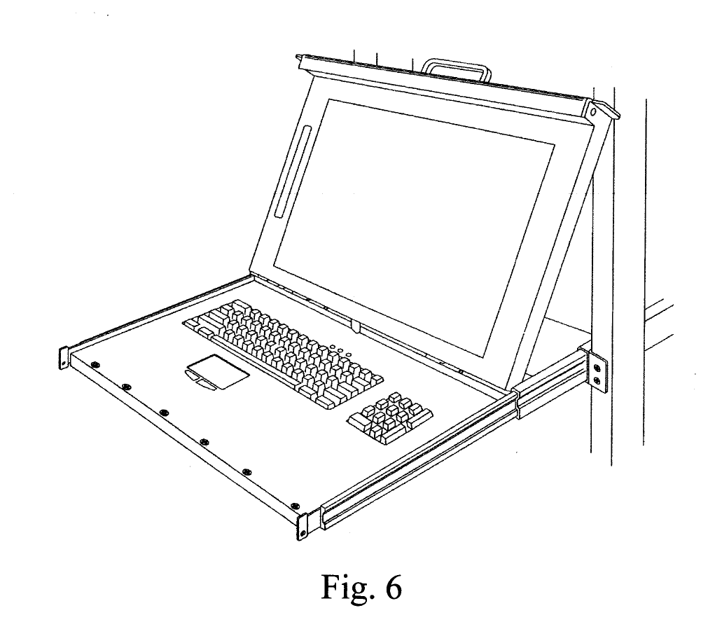

### SUMMARY OF THE PRESENT INVENTION

Accordingly, the primary object of the present invention is to provide a modularized industrial computer terminal having additional access unit for operating. The modularized wiring and component is easy for removing and replacing.

To achieve above object, the present invention provides a modularized industrial computer terminal including an upper cover, lower cover, and a wire collecting module.

The upper cover and the lower cover is pivoted to each other. The upper cover has a display.

The lower cover has a keyboard and at least one access unit. The keyboard is arranged to an upper surface of the lower cover, and the access unit is arranged inside the lower cover. The access unit can be a connecting module having USB or mini USB ports, or the access unit can be a storage module having a hard drive or disc drive.

The wire collecting module is electrically connected to the display, keyboard, access unit, and an external industrial computer main frame.

Through the modularized industrial computer terminal, the access unit and wire collecting module will improve the data storage and the maintenance of the device.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

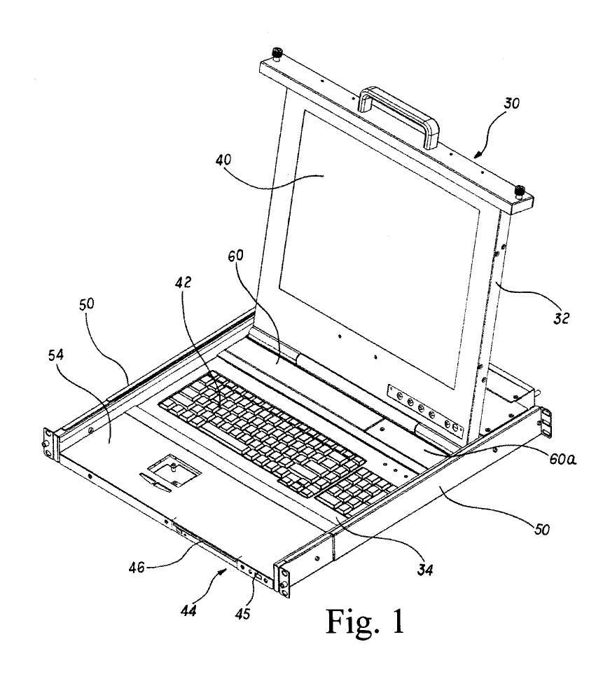

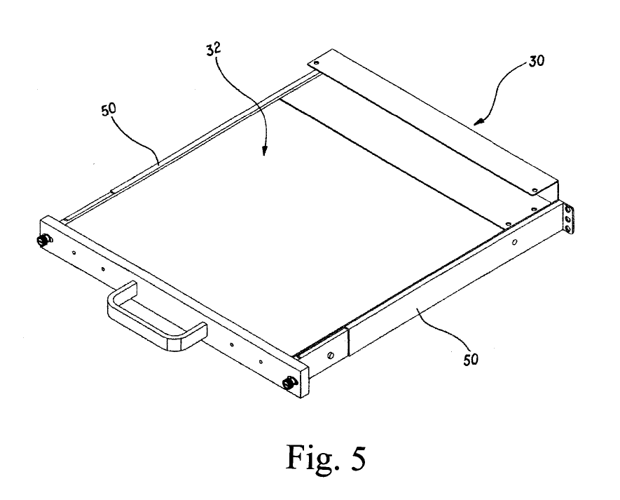

Referring to FIG. 1, an industrial computer terminal 30 according to the present invention is illustrated. The industrial computer terminal 30 is lifted up for operating in the Figure. With an upper cover 32 and a lower cover 34 pivoted to each other, the industrial computer terminal 30 can be folded up and received by an array rack as shown in FIG. 5.

A display 40 on an inner surface of the upper cover 32 and a keyboard 42 on an upper surface of the lower cover 34 are revealed while the upper cover 32 is lift up. An access unit 44 of the industrial computer terminal 30 includes a connecting module 45 such as a USB port or a mini USB port and a storage module 46 such as a disc drive or a hard drive.

A wire collecting module 48 is arranged to the lower cover 34 near to a pivot axle of the lower cover 34 and the upper cover 32.

The industrial computer terminal 30 is arranged to a sliding guide set 50 so that the industrial computer terminal 30 can be drawn out or received by the array rack. The industrial computer terminal 30 has a height below one standard unit (height U) so as to match the array rack.

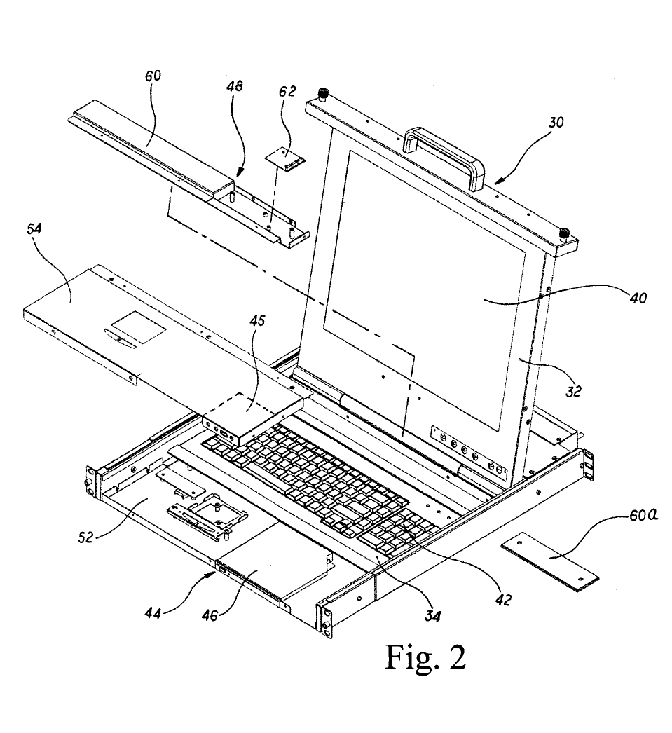

Referring to FIG. 2, an exploded view of the industrial computer terminal 30 according to the present invention is illustrated. The industrial computer terminal 30 includes the upper cover 32, lower cover 34, and a wire collecting module 48. The upper cover 32 and the lower cover 34 are pivoted to each other so that the upper cover can be folded toward the lower cover 34.

The upper cover 32 includes the display 40 for displaying processing information. The lower cover 34 includes the keyboard 42 on the upper surface thereof and at least one access unit 44 inside thereof.

The wire collecting module 48 is electrically connected to the display 40, keyboard 42, access unit 44, and an external industrial computer main frame (not shown in FIGS.).

The lower cover 34 further has a base 52 and a panel 54. The panel covers upon part of the base 52 as a casing of the case 52. The access unit 44 has the connecting module 45 integrated to the panel 54 and a storage module 46 arranged inside the base 52. The modules are easily to install and remove.

Moreover, the wire collecting module 48 has a wire collecting board 62 being covered by casings 60 and 60a. Electrical wires from the display 40, keyboard 42, access unit 44, and external industrial computer main frame are all connected to the wire collecting module with terminals so that any remove and replace is easy to be done.

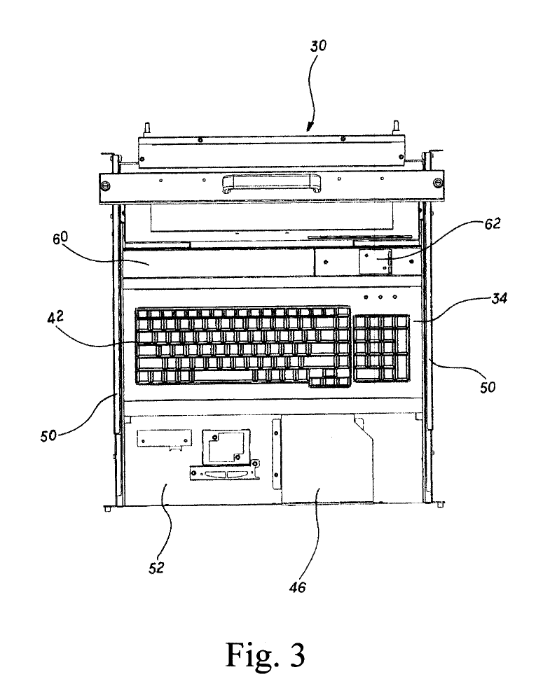

Referring to FIG. 3, a top view of the industrial computer terminal 30 without a panel 54 is illustrated. The arrangement of the storage module 46 inside the base 52, keyboard 42 and wire collecting module 48 below the lower cover 34 is shown. The wire collecting board 62 is also shown without the removable casing 60a.

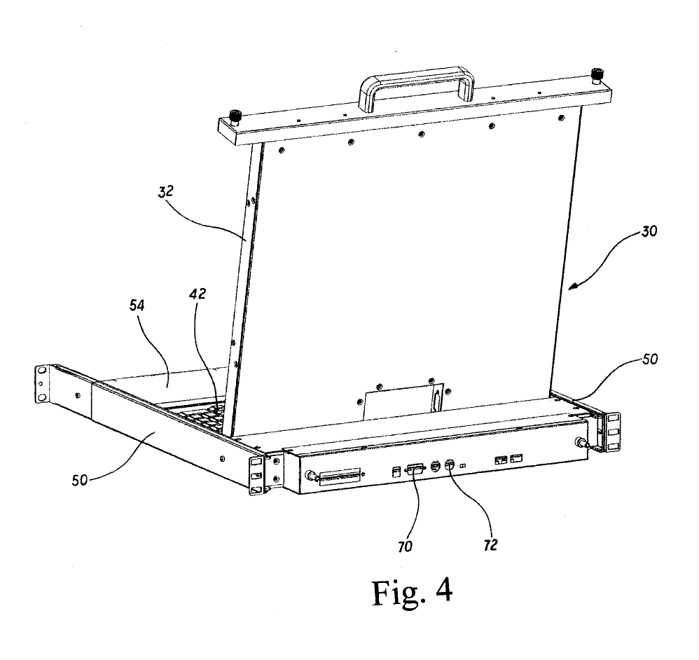

Referring to FIG. 4, a rear view showing a lifted up industrial computer terminal 30 is illustrated. Terminals 70 and connectors 72 formed on a back of the wire collecting module 48 serve to be connected by signal cables from the external industrial computer main frame.

Through the modularized industrial computer terminal 30 according to the present invention, the access unit 44 and wire collecting module 48 will improve the data storage and the maintenance of the device.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An industrial computer terminal comprising:
an upper cover having a display;
a lower cover pivoted to the upper cover; the upper cover being lifted up from and folded up to the lower cover; the lower cover further including a keyboard on a surface thereof, and at least one access unit having at least one of a connecting module or a storage module.

2. The industrial computer terminal as claimed in claim 1, wherein a plurality of access unit is included; each access unit has at least one of the connecting module or the storage module.

3. The industrial computer terminal as claimed in claim 2, wherein the connecting module is one of a USB or a mini USB connecting port.

4. The industrial computer terminal as claimed in claim 1, wherein the lower cover further has a base and a panel; the panel covers upon part of the base as a casing of the base; the connecting module is arranged to an inner surface of the panel.

5. The industrial computer terminal as claimed in claim 1, wherein the lower cover further includes a base and a panel; the panel covers upon part of the base as a casing of the base; the storage module is arranged to the base.

6. The industrial computer terminal as claimed in claim 1, wherein the industrial computer terminal is fixed to a sliding guide set; the industrial computer terminal has a height below one standard unit (height U).

7. The industrial computer terminal as claimed in claim 1, wherein the industrial computer terminal further has a wire collecting module electrically connected to the display, keyboard, access unit, and an external industrial computer main frame.

8. The industrial computer terminal as claimed in claim 7, wherein the wire collecting module is arranged to the lower cover below a pivot axle of the upper cover and the lower cover.
